(19) United States
(12) Patent Application Publication
(10) Pub. No.: US 2012/0178071 A1
(43) Pub. Date: Jul. 12, 2012

(54) Mobile Observation Panel

(76) Inventor: Joseph Burns, Landenberg, PA (US)

(21) Appl. No.: 13/343,811

(22) Filed: Jan. 5, 2012

Related U.S. Application Data
(60) Provisional application No. 61/430,315, filed on Jan. 6, 2011.
(60) Provisional application No. 61/521,645, filed on Aug. 9, 2011.

(51) Int. Cl. G09B 23/28; G02B 7/182

(52) U.S. Cl. 434/262; 359/839

(57) ABSTRACT

An apparatus for visually isolating an observer from an observed individual comprises a two way mirror forming a first panel and a movable frame disposed to hold the first panel in a vertical orientation; methods of assembling and operating instructional simulation lab, methods for instruction/proctoring/operating/repurposing a nursing simulation lab comprising the steps of identifying a space having a simulated patient location and an observation location, providing a panel assembly having a two way mirror, locating the panel assembly between the simulated patient location and the observation location, providing a patent simulation system including a simulated patient, providing a lab student, providing a lab instructor and/or observer, administering care to the simulated patient at the simulated patient location, and observing the administration of care at the observation location by looking towards the simulated patient location through the two way mirror.

### CROSS REFERENCE TO RELATED APPLICATIONS

This application claims priority of and incorporates by reference as if set forth herein in its entirety: U.S. patent application Ser. No. 61/430,315 filed on Jan. 6, 2011, and U.S. patent application Ser. No. 61/521,645 filed on Aug. 9, 2011.

### BACKGROUND OF INVENTION

a. Field of Invention

The invention relates generally to observation panels. In particular, a mobile panel having a two way mirror used for observation of the rendering of medical care to a simulated patient.

The invention relates to a mobile apparatus for visually isolating an observer from an observed individual, and a method of constructing the same.

The invention relates generally to methods of assembling and operating instructional simulation labs.

The invention relates generally to methods for observing and making the observer (instructor) unobtrusive during the simulation, and in particular, methods for instruction/proctoring/operating a nursing simulation lab.

b. Description of Related Art

In the field of clinical education, in particular the field of nursing instruction, clinical performance is a core component of the education curriculum. Clinical curriculum is, where medical students, including nursing students, train and are observed in practitioner-patient relationships. In the field of nursing, for example, nursing students are observed by instructors, and the students are presented with near real life situations that approximate actual patient-practitioner situations. In the ideal clinical setting, students are presented with a patient in a hospital, and the student's performance is observed and evaluated by instructors. Because of liability concerns, medical colleges have increased the use of simulation labs to approximate the practitioner-patient situation. The clinical setting is removed from the hospital and provided in labs on site at the medical college.

Technology has lead to the advent of sophisticated mannequins that make vibrations, sounds, and movements, contain sensors and control equipment that is operated by an instructor/observer. In the ideal setting, medical colleges have simulation facilities constructed with walls having observation mirrors to separate the patient and students from the operator/observer and control equipment. Some facilities have closed circuit audio and visual equipment to facilitate observation by instructors.

The recent onset has occurred with such speed that many teaching schools lack the “ideal” observation facilities. Moreover, the capital improvement costs associated with the construction of simulation labs having a control room and observation room and audio visual equipment is significantly costly.

Presently, many teaching institutions make do by improvising a physical barrier between the patient/students and the operator/observer. Examples include separating the patient side from the observer side with a sheet or curtain, which is hung from the ceiling. This method has resulted in difficulties. The instructor is unable to observe the students without manipulating the curtain to see the students. This activity, in turn, defeats the element of isolation needed between the instructor/observer and the students. Often, the students lose focus because of the disturbance, and the students initiate communication with the observer. Another example of an attempt to create a isolation/observation barrier included the use of a vary large table, turned on its side, having a hole cut into the center, positioned to isolate the students from the observer. These crude attempts have not resolved the drawbacks.

Accordingly, there is a need to provide medical instruction institutions with devices and methods to provide a more ideal clinical setting. A setting where the observer is isolated from the students and is allowed freedom to observe student performance and operate the mannequin controls. There is a need to achieve these results without undertaking the significant costs and time delay in constructing observation laboratory having separate observation rooms. Accordingly, it is object of the present invention to provide methods and devices that are used facilitate clinical instruction and observation without significant costs and delay.

### SUMMARY OF INVENTION

In some preferred embodiments of the present invention an apparatus for visually isolating an observer from an observed individual comprises:

a two way mirror forming a first panel; and

a movable frame disposed to hold the first panel in a vertical orientation, the movable frame including:
a first foot member extending generally parallel with the floor in a generally horizontal position,
a first leg member having a foot end attached to the first foot member and extending generally vertically from the first foot member,
a second foot member extending generally parallel with the floor in a generally horizontal position,
a second leg member having a foot end attached to the second foot member and extending generally vertically from the second foot member, and
a cross member connecting the first and second leg members; wherein, the apparatus placed in a location such that the observed individual is physically separated from the observer by the apparatus, and wherein, the observer may view the observed individual through the first panel of the apparatus, and a view from the observed individual to the observer through the first panel is obscured.

In a preferred embodiment of the invention, the apparatus further includes one or more casters attached or attachable to the movable frame to facilitate movement of the movable frame.

In another preferred embodiment of the invention, the apparatus further includes a second panel held by the movable frame in a vertical orientation and located below the first panel.

In another preferred embodiment of the invention, the apparatus further includes a second cross member connecting the first and second leg members located between the first and second panels.

In another preferred embodiment of the invention, the apparatus further includes a foldable shelf to allow the observer to place items such as a computer or notebook.

In another preferred embodiment of the invention, the first panel begins at the height of a standard desk and extends upwardly to a desired height.

The invention further includes a method of instructing/proctoring/operating a medical care simulation lab comprising the steps of:

identifying a space having a simulated patient location and an observation location,

providing a panel assembly having a two way mirror,

locating the panel assembly between the simulated patient location and the observation location,

providing a patent simulation system including a simulated patient,

providing a lab student,

providing a lab instructor and/or observer,

administering care to the simulated patient at the simulated patient location, and

observing the administration of care at the observation location by looking towards the simulated patient location through the two way mirror.

In another preferred embodiment, the method further includes the step of moving the panel assembly from a first location to a second location by grasping and/or pushing the panel assembly away from the first location under the force of a single individual.

The invention further includes a method of furnishing an existing space to accommodate clinical observation in a medical instruction school comprising the steps of:

identifying a space having a patient location and an observation location,

providing one or more two way mirrors, and

wheeling said two way mirrors within a line of sight space between the patient location and the observation location.

The invention further includes a method of constructing a mobile observation panel comprising the steps of:

providing a two way mirror,

constructing a mobile frame having a mobile frame width defined by the distance between an observer side and an observed side of said frame,

mounting the two way mirror vertically within the mobile frame such that the two way mirror is located closer to the observed side, thereby creating a observer side sill extending roughly perpendicular to the two way mirror, the observer side sill, at least in part, coated with a light absorbing material, or comprised of a light absorbing color, and

fixing wheels or casters to the mobile frame to facilitate movement or resting the mobile frame on an apparatus having casters or wheels to facilitate movement.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is an isometric view of an embodiment of a present invention apparatus observation panel;

FIG. 2 is a plan view of a clinical simulation lab employing a plurality of the present invention apparatus observation panel; and

FIG. 3 is a partial cross section of the apparatus observation panel.

### DETAILED DESCRIPTION OF THE EMBODIMENTS

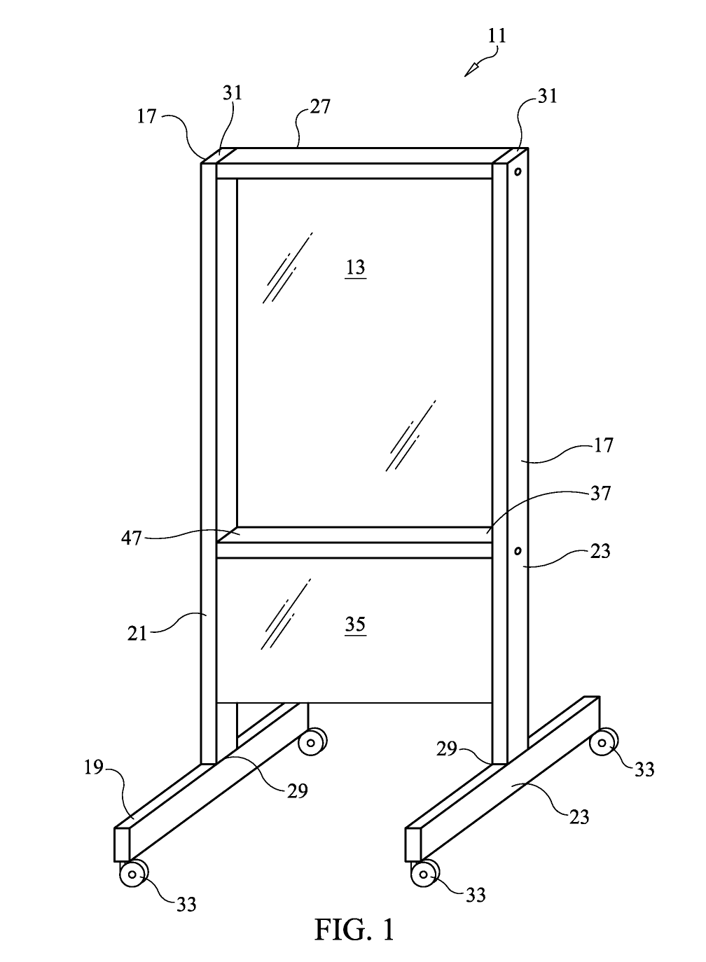

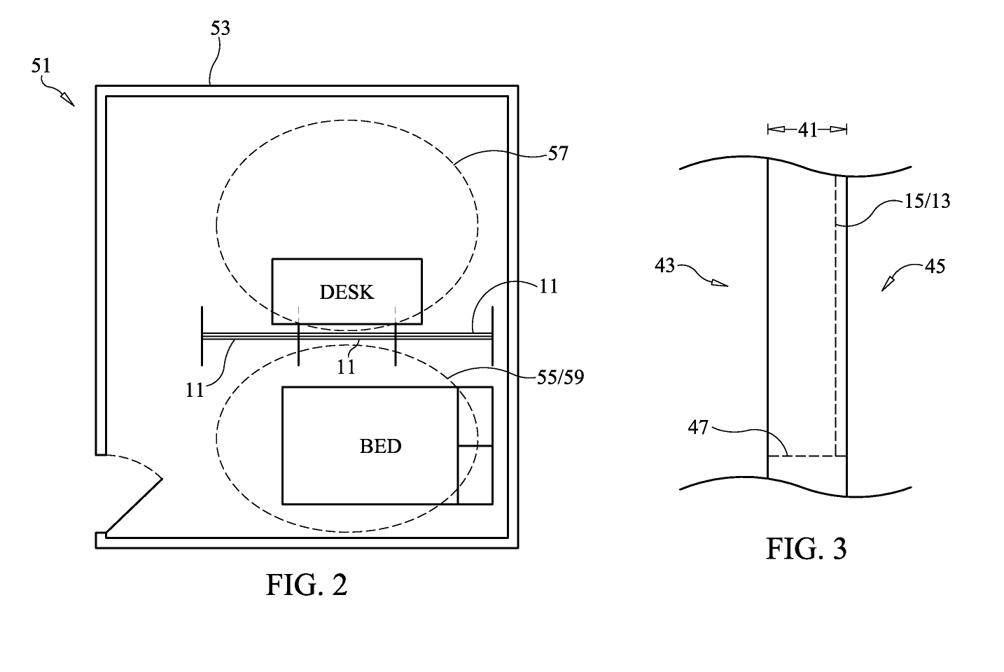

Turning to the drawings, which complement the present the description, the invention relates generally to an apparatus 11 for visually isolating an observer from an observed individual. Referring to FIG. 1, the apparatus 11 comprises a two-way mirror 13, which forms a first panel 15. The apparatus 11 further includes a movable frame 17 that is adapted to hold the first panel 15 in a vertical orientation. The movable frame 17 includes a first foot member 19 connected to a first leg member 21, a second foot member 23 attached to a second member 25, and at least one cross member 27 connecting the first and second leg members 21, 25.

The first foot member 19 extends generally in a direction parallel with the floor, in a generally horizontal position. The first leg member 21 has a foot end 29 that is attached to or integral to the first foot member 19. The first leg member 21 extends generally vertically upward from the first foot member 19 to a top end 31. The second foot member 23 extends generally parallel with the floor in a generally horizontal position. The second foot member 23 is attached to, or integral with a second leg member 25 at a foot end 29. The second leg member 25 extends generally vertically upward from the second foot member 23 to a top and 31. The cross member 27 connects the first and second leg members 21, 25. In a preferred embodiment, the cross member 27 connects the first and second leg members 21, 25 each at the top end 31. In alternate embodiments, the first panel 15 may form the cross member 27.

The two-way mirror 13 preferably is Mirrorpane TM glass panels, but other two-way mirror may work to achieve the desired results. A two-way mirror, also known as a one-way mirror, one-way glass, or two-way glass, is a mirror that is partially reflective and partially transparent. When one side of the mirror is brightly lit, and the other is darker, it allows viewing from the darkened side, and the brighter side viewing is diminished. The materials for the movable frame 17 preferably comprises stainless steel or aluminum, but alternate materials may suffice to achieve the desired structural support and other desired results. In a preferred embodiment, the movable frame 17 is formed from square or rectangular tubing.

In a preferred embodiment, one or more casters 33 are attached to the movable frame 17 at the first and second foot members 19, 23 to facilitate movement of the apparatus 11. In an alternate embodiment, the one or more casters 33 or wheels, may be removable from the frame or lockable if desired.

A preferred embodiment of the invention includes a second panel 35. The second panel 35 is held by the movable frame 17 in a vertical orientation and located below the first panel. Because viewing in either direction through the second panel 35 is not desired, the second panel 23 may be constructed of other opaque materials such as pvc or wood. A second cross member 37 connects the first and second leg members 21, 25 at a location between the first and second panels 15, 35. An alternative embodiment includes a foldable shelf 39 (not shown) attached to the movable frame 17. The foldable shelf 39 is adapted to allow the observer to place items and store items such a computer or notebook while the observer is viewing the observed individual through the apparatus 11.

In some embodiments the first panel 15 begins at the height of a standard desk and extends upwardly to desired height that is typically lower then the ceiling of the space. In a preferred embodiment, the first panel 15 of the apparatus 11 extends to approximately 6 foot tall and is 3 foot wide. Multiple apparatus 11 are often butted together side by side to provide a wider viewing area. In a preferred embodiment, the apparatus 11 has a flange that adapted to extend from the movable frame 17 overlapping a portion of the movable frame 17 of another of the apparatus 11, for providing coverage over any gaps existing between the apparatus 11 and another apparatus 11 on the side of the movable frame. Photographs submitted as the appendix to provisional patent application No. 61/430,315 disclose said flanges.

Referring to FIG. 3, the movable frame 17 has a movable frame width 41 that is defined by the distance between the observer side 43 of the frame and the observed side 45 of the frame 17. Preferably, the two-way mirror 13 is mounted vertically within the movable frame 17 such that the two-way mirror 13 is located closer to the observed side 45 than it is to the observer side. An observer side sill extends roughly perpendicular to the two-way mirror 13 within, or formed as part of the movable frame 17. The observer side sill 47 preferably is coated with a light absorbing material such as a lamented tape, paint, or other materials to improve the two-way mirror characteristics, causing improved viewing from the observer side 43 relative to the view through the two-way mirror 13 from the observed side 45. The observer side sill 47 extends horizontally and vertically along leg members 21, 25 and the cross members 27, 37, of the observer side, and in a preferred embodiment, the light absorbing material is applied to the sill to improve the viewing characteristics of the two-way mirror making it easier to see through from the observer side to the observed side—and more difficult to view in the opposite direction.

The invention further includes a method of instructing or proctoring or operating a medical care simulation lab 51. The method includes the following steps. A space 53 is identified having a simulated patient location 55 and an observation location 57. The simulated patient location 55 is the location where medical students provide simulated care to the simulated patient. Typically, this involves the use of a simulation mannequin on a hospital bed in a setting designed to simulate a hospital setting. Many simulation labs are known in the art, and typically involve the use of a simulated patient, such as a mannequin fixed to a gurney or a hospital bed. The observation location 57 typically is a location set off in distance by 3 to 6 feet from the simulated patient location 55. However, any distance feasible to the care observation process will suffice. At the observation location 57, an instructor typically observes the students and operates the controls for the simulation patient or mannequin. A panel assembly 11 having a two-way mirror 13 is provided. Multiple panel assemblies 11 may be utilized. The panel assembly 11 is located between the simulated patient location 55 and the observation location 57. The order of steps of the method may be modified. For example, the panel assembly 11 can be located between the simulated patient location 55 and the observation location 57 selectively at different times, as dictated by the situation at hand. Preferably, the location step is accomplished by wheeling said panel assembly 11. However, the assembly may be carried by one or more persons to achieve the location step, if the assembly is without casters.

A patient simulation system such as an automated or computer controlled simulation patient mannequin is provided. Lab student and instructors and/observers participate generally as follows. Care is administered to the simulated patient at the simulated patient location 55 and the instructor/observer observes the administration of care at the observation location 57 by looking towards the simulated patient location 55 through the two-way mirror 13 of the apparatus 11 to the observation location 57. The operation of the simulated patient/mannequin may be initiated by the instructor/observer.

Preferably, the method includes the step of moving the panel assembly 11 from a first location to a second location by grasping, pushing, or pulling the panel assembly 11 away from the first location under the force, or by the force, of a single individual.

Multiple instances of the apparatus 11 in varying dimensioning and configuring may be utilized to form a cube, parto of a cube, discontinuous walls forming right angles, or partitions about the observation location 57.

In an embodiment of the present invention, the method may include the repurposing (or modifying the purpose of) the identified space 53 (typically a room constructed of permanent walls) such that the space 53 is be utilized for training and instruction where isolated viewing through a two-way mirror is unnecessary. For example, in group training, the instructor and a larger group of students may perform/observe procedures performed on the simulated patient. Visual isolation may be unnecessary, and the space occupied by the two-way mirror can be reclaimed and used for other purposes, such as for group instruction in connection with a simulated patient. This is accomplished by moving the panel assembly 11 (or multiple panel assemblies 11) from a first location to a second location by grasping, pushing, or pulling the panel assembly 11 away from the first location under the force, or by the force, of a single individual. Alternately, the assembly 11 may be carried or moved to a different location within the space 53, or the assembly 11 may be removed from the space entirely by carrying or wheeling the assembly 11 away intact.

In accordance with the present invention, an educational institution may utilize the present invention to accomplish training and certification of students in the field of clinical care. For example, in an embodiment of the invention, students are taught various concepts relating to the monitoring and treatment of patients. At some point, students are observed and/or graded on their performance in observing and treating patients and/or simulated patients. The observation/grading of the students is accomplished utilizing the present invention apparatus 11 and the methods discussed herein to visually separate or isolate the students from the observer/grader.

In accordance with the present invention, an instructor utilizes a space 53 at a first phase to instruct an entire class of clinic students on monitoring and administering care to patients utilizing a simulated patient located within the space. With an entire class of students present, sufficient area within the space 53 is made available so the instructor can teach the class various concepts and procedures relating to medical care of a patient. The apparatus 11 may be moved about the space 53. At a second phase, an instructor utilizes the space 53 to observe and/or grade a student's performance in monitoring and administering care to a simulated patient. This may be accomplished utilizing the apparatus and methods described herein to visually isolate the student from the instructor/observer, without the need for costly reconstruction of framed walls and/or the installation of video equipment.

The invention further includes a method of furnishing an existing space 53 to accommodate clinical observation in a medical instruction school. The method comprises the steps of identifying a space 53 having a patient location 59 and an observation location 57. One or more two-way mirrors are provided 13, and said two-way mirrors 13 are wheeled within the space between the patient location 59 and the observation location 57.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

1. An apparatus for visually isolating an observer from an observed individual comprising:
a two way mirror forming a first panel; and
a movable frame disposed to hold the first panel in a vertical orientation, the movable frame including:
a first foot member extending generally parallel with the floor in a generally horizontal position,
a first leg member having a foot end attached to the first foot member and extending generally vertically from the first foot member,
a second foot member extending generally parallel with the floor in a generally horizontal position,
a second leg member having a foot end attached to the second foot member and extending generally vertically from the second foot member,
a cross member connecting the first and second leg members;
wherein, the apparatus placed in a location such that the observed individual is physically separated from the observer by the apparatus, and wherein, the observer may view the observed individual through the first panel of the apparatus, and a view from the observed individual to the observer through the first panel is obscured.

2. The apparatus of claim 1, further including one or more casters attached or attachable to the movable frame to facilitate movement of the movable frame.

3. The apparatus of claim 2, further including a second panel held by the movable frame in a vertical orientation and located below the first panel.

4. The apparatus of claim 3, further including a second cross member connecting the first and second leg members located between the first and second panels.

5. The apparatus of claim 4, further including a foldable shelf to allow the observer to place items such as a computer or notebook.

6. The apparatus of claim 5, the first panel beginning at the height of a standard desk and extend upwardly to a desired height.

7. A method of instructing/proctoring/operating a medical care simulation lab comprising the steps of:
identifying a space having a simulated patient location and an observation location,
providing a panel assembly having a two way mirror,
locating the panel assembly between the simulated patient location and the observation location,
providing a patent simulation system including a simulated patient,
providing a lab student,
providing a lab instructor and/or observer,
administering care to the simulated patient at the simulated patient location, and
observing the administration of care at the observation location by looking towards the simulated patient location through the two way mirror.

8. The method of claim 5, further including the step of moving the panel assembly from a first location to a second location by grasping and/or pushing the panel assembly away from the first location under the force of a single individual.

9. A method of furnishing an existing space to accommodate clinical observation in a medical instruction school comprising the steps of:
identifying a space having a patient location and an observation location,
providing one or more two way mirrors, and
wheeling said two way mirrors within the space between the patient location and the observation location.

10. (canceled)
